(19) United States
(12) Patent Application Publication
(10) Pub. No.: US 2018/0296011 A1
(43) Pub. Date: Oct. 18, 2018

(54) Measuring Spice Dispenser

(71) Applicant: Tanya Valles, La Puente, CA (US)

(72) Inventor: Tanya Valles, La Puente, CA (US)

(21) Appl. No.: 15/953,355

(22) Filed: Apr. 13, 2018

Related U.S. Application Data
(60) Provisional application No. 62/484,909, filed on Apr. 13, 2017.

(51) Int. Cl. A47G 19/34; B65D 83/06; B65D 41/26

(52) U.S. Cl. CPC A47G 19/34; G01F 11/261; B65D 41/26; B65D 83/06

(57) ABSTRACT

A spice jar equipped with a twist-top measuring mechanism enabling the cook to choose the desired amount of spice, and then dispense that amount of spice.

### CLAIM OF PRIORITY

This patent application claims priority under 35 USC 119 (e) (1) from U.S. Provisional Patent Application Ser. No. 62/484,909 filed Apr. 13, 2017, of common inventorship herewith entitled, “EZ SPICE,” which is incorporated herein by reference as though the same were set forth in its entirety.

### FIELD OF THE INVENTION

The present invention pertains to the field of spice jars, and more specifically to the field of spice jars equipped with a twist-top measuring mechanism enabling the cook to choose the desired amount of spice, and then dispense that amount of spice, neatly and without overflow and without the need for measuring spoons.

### BACKGROUND OF THE INVENTION

If variety is the spice of life, then surely spices are the variety in cooking. Every supermarket in America features a large selection of spices from around the world, and virtually every household has one or more spice-shelves in their kitchen cupboards. And every time the cook goes to add a spice to a dish-in-progress, she goes first to a drawer for the measuring spoons. This is just another step in the cooking, and another utensil to wash, of course, but what if this step could be eliminated? If would be desirable if the spice jar itself, with a simple, quick movement on the part of the cook, could measure-out and dispense the spice.

The prior art has put forth several designs for dispensing devices. Among these are:

U.S. Pat. No. 6,601,734 to William G. Smith describes a measuring and dispensing device having a container cap securely fastened to a container by screw threads or other suitable means; two piece rotatable metering drum connected to the cap by a rotatable, snap-action ring; and an exit spout on the opposite end of the metering drum attached to the drum by a rotatable, snap-action ring. An objective in the development of the present device was to reduce the height of the metering drum which is achieved by splitting the metering drum along a parting line, and then permanently joining the two parts by a non-rotatable locking snap-action ring so that the entrance and exiting openings to the metering drum are approximately ⅜ inch in diameter while the interior of the metering drum chambers vary in size to accommodate the ¼, ½, and 1 teaspoon measurement amounts.

U.S. Pat. No. 5,465,871 to Edward S. Robbins III describes a dispensing cap which incorporates a volumetric space to thereby permit precisely measured amounts of contents to be poured from the dispensing cap. The cap in this exemplary embodiment is constructed of a transparent plastic material and is provided with volume indicators to assist the user in measuring precisely desired amounts as the contents are transferred from the jar into a volumetric space provided in the dispensing cap.

U.S. Pat. No. 5,601,213 to Jennifer J. Daniello describes a container lid with quantity measures for the selective dispensing of different predetermined quantities of material from a container to which the lid is removably attached. The lid includes a central body portion having a plurality of differently sized volumes therein, each of which is selectively openable and closable relative to the container to which the lid is secured. A rotatable top portion is turned to select the desired specific quantity, which action also turns the closure plate below the main body portion. The container lid is used by inverting the container and attached lid, rotating the top portion to a position other than the quantity selected in order to move the closure plate from that selected volume, rotating the top portion to the selected quantity to close the selected volume, and dispensing the selected quantity from a dispenser in the top portion. The configuration of the main body portion also allows the closure plate or valve to be bypassed, to a low continuous pouring or shaking of material from the container as desired. The present container lid is particularly adapted for use in the dispensing of specific quantities of spices, condiments, and the like for cooking and food preparation, but may be used to dispense virtually any dry granulated or powdered material, and may even be adapted for use with certain liquids.

None of these prior art references describe the present invention.

### SUMMARY OF THE INVENTION

It is an object of the present invention to provide a spice jar equipped with a twist-top measuring mechanism enabling the cook to choose the desired amount of spice, and then dispense that amount of spice, neatly and without overflow and without the need for measuring spoons.

### BRIEF DESCRIPTION OF THE DRAWINGS

FIG. 1 is a front perspective view illustrating a spice dispenser, constructed in accordance with the present invention.

FIG. 2 is a front perspective view illustrating the primary storage portion of the spice dispenser constructed in accordance with the present invention.

FIG. 3 is a top down view of the top of rotatable partitioned chamber, constructed in accordance with the present invention.

FIG. 4 is a top down perspective view of the rotatable bifunctional hinged lid constructed in accordance with the present invention.

FIG. 5 is a perspective side view illustrating the bifunctional hinged lid shown in FIG. 4 constructed in accordance with the present invention.

FIG. 6a is a front perspective view of an embodiment of the present invention showing of the shape of a first well of rotatable partitioned chamber.

FIG. 6b is a front perspective view of an embodiment of the present invention showing of the shape of a second well of rotatable partitioned chamber.

FIG. 6c is a front perspective view of an embodiment of the present invention showing of the shape of a third well of rotatable partitioned chamber.

FIG. 6d is a front perspective view of an embodiment of the present invention showing of the shape of a fourth well of rotatable partitioned chamber.

FIG. 7a is a front perspective view of an alternative embodiment of the present invention showing of the shape of a first well of rotatable partitioned chamber.

FIG. 7b is a front perspective view of an alternative embodiment of the present invention showing of the shape of a second well of rotatable partitioned chamber.

FIG. 7c is a front perspective view of an alternative embodiment of the present invention showing of the shape of a third well of rotatable partitioned chamber.

FIG. 7d is a front perspective view of an alternative embodiment of the present invention showing of the shape of a fourth well of rotatable partitioned chamber.

FIG. 8 is a front perspective view of a further alternative embodiment of the spice dispenser of the present invention showing the dispenser having a rotatable partitioned chamber at both ends of the storage portion for a total of two rotatable chambers.

FIG. 9 is a top down view of the storage portion apertured cover.

### DETAILED DESCRIPTION OF THE INVENTION

The present invention is a Measuring Spice Dispenser providing a spice container equipped with one or two twist-top measuring mechanisms enabling the cook to simply choose the desired amount of spice, and then, in a couple of quick and easy moves, dispense that amount of spice, neatly and without overflow and without the need for measuring spoons.

Please refer to the drawings.

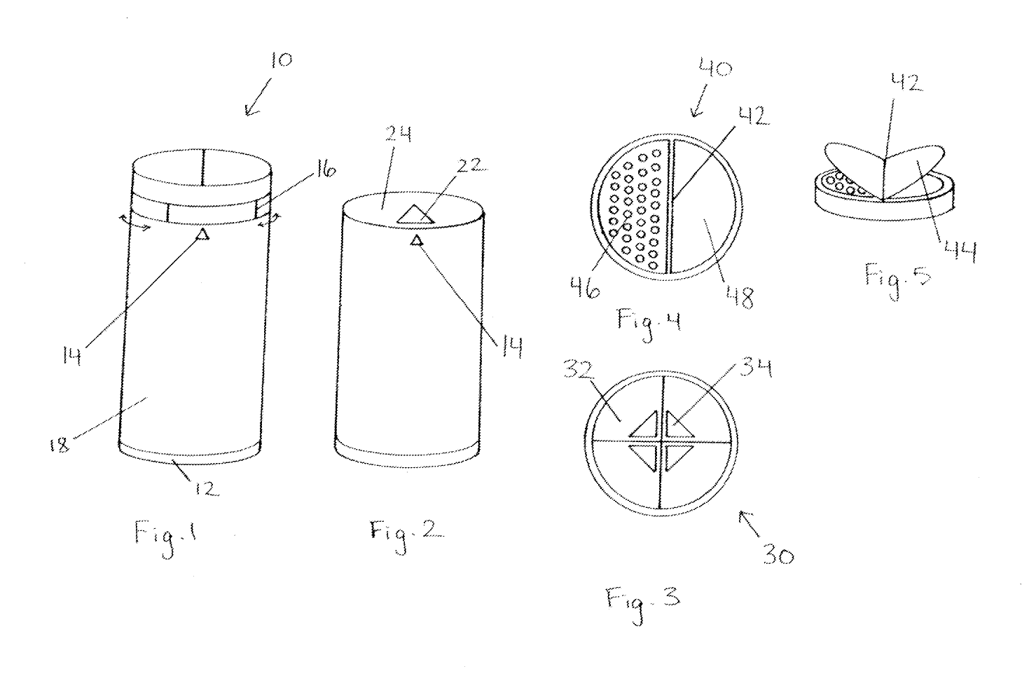

The Measuring Spice Dispenser of the present invention is preferably fabricated in injection-molded, food-grade thermoplastic, and can be produced in a variety of sizes. The size of the Dispenser can be any suitable size for the desired purpose. Regardless of size, the Measuring Spice Dispenser is a cylindrical container having three primary elements. The lower element is primary storage portion 18. Primary storage portion 18, shown in FIG. 2 stores spice, herbs or other dry or powdered, granulated, or appropriately fractionated materials. Hereinafter, the term “spice” will be used to comprise any aforementioned material or any other material suitable for use in the dispenser. Primary storage portion 18 is a cylindrical container having a triangle indicator 14 and a triangular aperture 22 in apertured cover 24 for the egress of spice therethrough. Apertured cover 24 has a perimeter edge. Triangular aperture 22 is positioned at the perimeter edge of apertured cover 24. Triangle indicator 14 is positioned on the outside of the cylindrical container directly below the aperture to show the position of the aperture. Primary storage container also has an opening bottom 12 to allow for the introduction of spice into the storage container 18.

The second primary element is the rotatable partitioned chamber 30. It is contemplated that one or more rotatable partitioned chambers can be utilized. Rotatable partitioned chamber 30 is positioned immediately above and in direct contact with primary storage portion 18. Rotatable partitioned chamber 30 has an aperture 34 and is in contact with storage chamber 18. Aperture 34 allows spice to pass from the storage container 18 through aperture 24 on cover 22 into the partitioned chamber 30. This contact can be any suitable means of contact as is known in the art such as snap on twist top having circumferential tongue and groove to allow for rotation alone or in combination with threaded communication. Rotatable partitioned chamber comprises a multiplicity of wells.

Above the storage portion 18 of the Spice Dispenser 10 is the measured cylindrical dispensing device comprising a rotatable partitioned chamber 30, shown in FIG. 3. Rotatable partitioned chamber 30 is rotatable by a user. Rotatable partitioned chamber 30 can rotate in a clockwise direction and can also rotate in a counter-clockwise direction. Rotation is indicated by the arrows on FIG. 1. Rotating rotatable chamber 30 causes a triangle or other indicator 14 to line up with a corresponding volume designation 16. Chamber 30 is shown with four separate radial wells 32. This number of wells is exemplary only. Any suitable number of wells such as less than four, or more than four is contemplated. Volume designation 16 indicates the specific volume of the well upon which it is printed. The specific volumes can be any desired amounts. In an embodiment, as shown in FIG. 8, the rotatable partitioned chamber 30 on the first end measures fractions of teaspoons and the rotatable partitioned chamber 30 on the second end measures tablespoons. In an alternative embodiment, in the first end measuring fractions of teaspoons, the first well measures ⅛ teaspoon, the second well measures ¼ teaspoon, the third well measures ⅓ teaspoon, and the fourth well measures ½ teaspoon; and the second end measuring tablespoons has two wells and measures ½ tablespoon and 1 tablespoon. In a further alternative embodiment, the amounts are ⅛ tsp., ¼-Tsp; ½-Tsp; 1-Tsp; ½ Tbsp. and 1-Tbsp. Rotatable partitioned chamber 30 also comprises an opening 34 through which the spice can exit the primary storage portion 18 into a well 32 of chamber 30. The user lines up the triangle indicator 14 with the desired volume to be dispensed, inverts the dispenser, rotates rotatable chamber 30 slightly in either direction to close the opening 34 through which the spice travelled. The user then turns the dispenser to the upright position. The desired amount of spice is now present in the chamber 30, and is ready for dispensing.

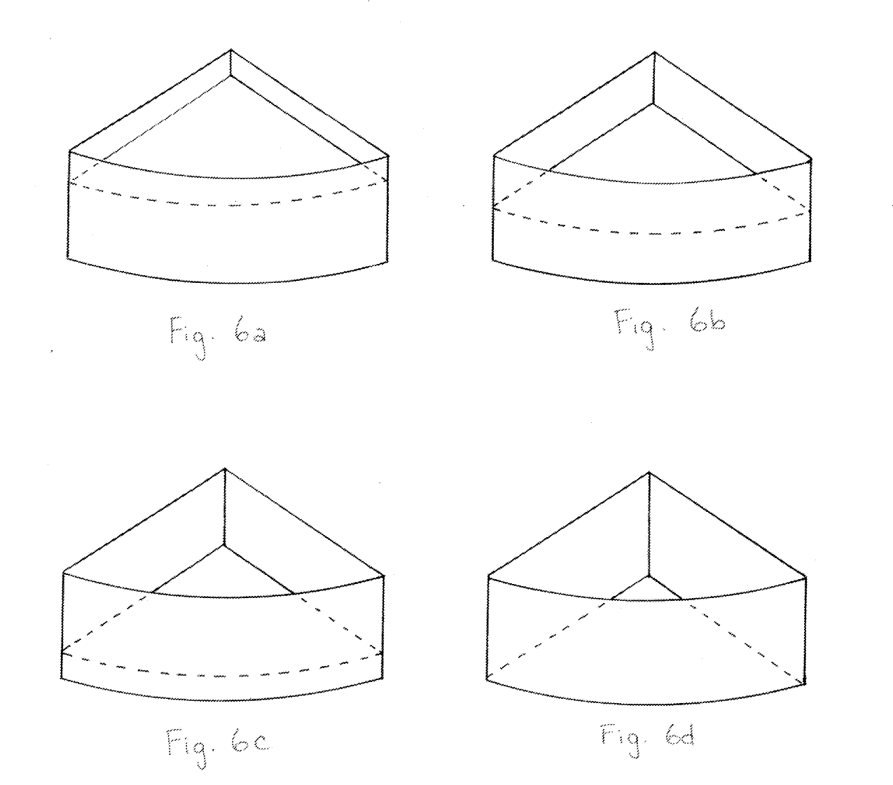

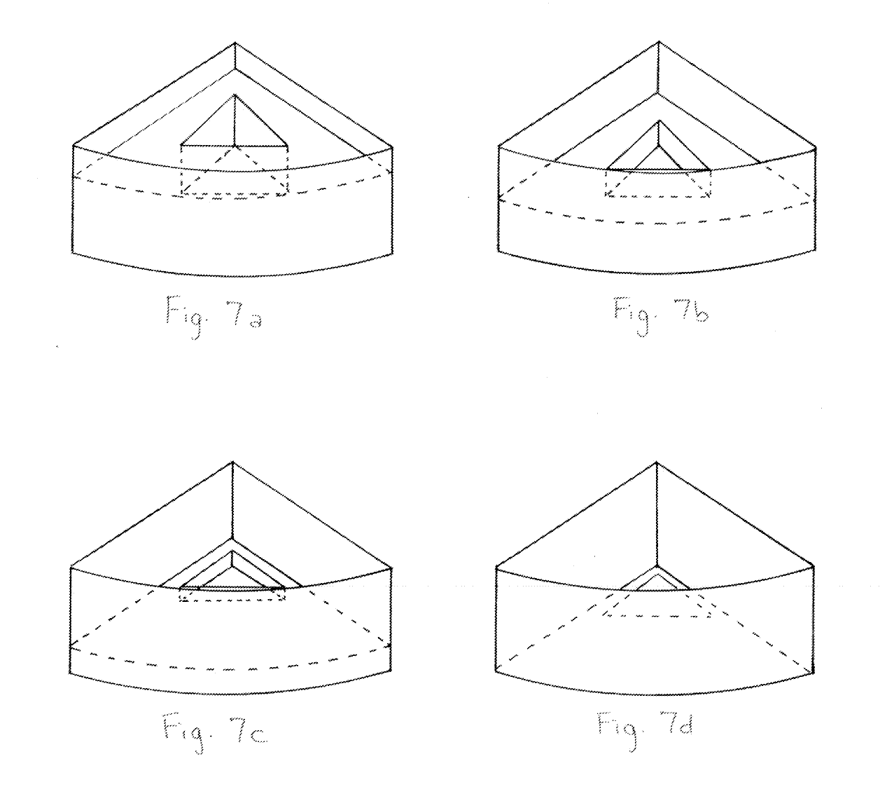

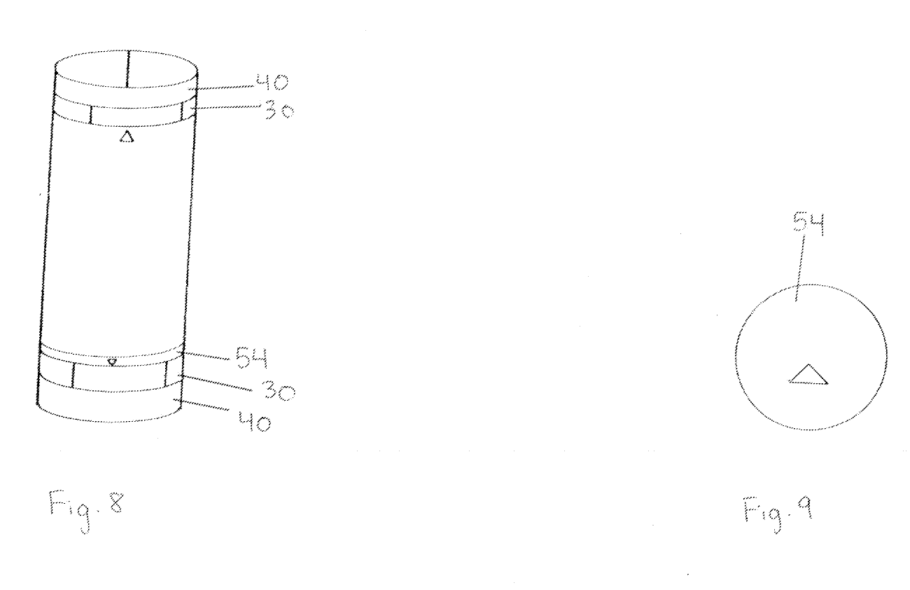

Rotatable bifunctional hinged lid 40 is shown in FIG. 4 and FIG. 5. FIG. 4 is a top down view of lid 40. FIG. 5 is a perspective side view of lid 40, showing semi-circular cover 44 in a slightly open configuration, exposing both sprinkler 46 and semi-circular opening 48. Bifunctional hinged lid 40 comprises a hinge 42, and a semicircular cover 44 which covers sprinkler portion 46, and open semi-circular opening 48. Hinge 42 traverses the diameter of the lid 40. To dispense the spice, the user rotates bifunctional hinged lid 40 to position the lid opening over the well 34 containing the spice, opens the desired side of the cover 44 to expose the spice and dispenses the spice.

In an alternative embodiment, FIG. 9 shows two rotatable chambers 30. One rotatable chamber is attached to each end of primary storage portion 18. In this embodiment, an additional apertured cover 54 replaces opening bottom 12 before the second rotating partitioned chamber 30 is attached to the storage portion 18. Apertured cover 54 matches the configuration of the cover 24 of the storage portion 18.

The present invention provides a quick, precise, waste-free, and easy spice dispenser that minimizes spills and eliminates the need to wash

In the Spice Dispenser, cooks have a quick and easy means of accurately and neatly measuring and dispensing spices. Whether in the household kitchen or the kitchen of a restaurant, the Spice Dispenser saves cooks time and trouble, ensure the precise, desired amount of spice every time, and make it as quick to add a ¼- or ½-Teaspoon as it is to add a “pinch” or “dash.” Clearly, by eliminating the need for the measuring spoons, the Spice Dispenser makes spicing things up a lot easier, and give cooks one less utensil to clean up. And while the end-users of the Spice Dispenser are household users and restaurants, this multi-functional measuring spice jar will appeal very strongly to the big names within the spice industry, who win customers and increase their market share by offering their spices in the Spice Dispenser.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A measuring spice dispenser comprising: a primary storage portion wherein the primary storage portion is a cylindrical container having a triangle indicator and a triangular aperture in an apertured cover, wherein the apertured cover has a perimeter edge; and wherein the triangular aperture is positioned at the perimeter edge of apertured cover; and wherein the triangle indicator is positioned on the outside of the cylindrical container directly below the aperture to indicate the position of the aperture: further wherein the primary storage container comprises an opening bottom; further comprising
at least one rotatable partitioned chamber positioned immediately above and in direct contact with primary storage portion, wherein the rotatable partitioned chamber comprises an aperture allowing spice to pass from the storage container through the aperture on the cover into the partitioned chamber; further wherein rotatable partitioned chamber comprising a multiplicity of wells; further wherein
a rotatable bifunctional hinged lid, wherein rotatable bifunctional hinged lid comprises a hinge traversing a diameter of the hinged lid, wherein the hinge connects a semi-circular cover which covers a sprinkler on one half of the lid to a semi-circular opening on the second half of the lid.

2. The measuring spice dispenser of claim 1, wherein the multiplicity of wells in the rotating partitioned chamber numbers 4.

3. The measuring spice dispenser of claim 1, wherein the multiplicity of wells in the rotating partitioned chamber numbers more than 4.

4. The measuring spice dispenser of claim 1, wherein the multiplicity of wells in the rotating partitioned chamber numbers less than 4.

5. The measuring spice dispenser of claim 1, wherein the wells are wedge-shaped.

6. The measuring spice dispenser of claim 1, wherein the wells have specific volumes of fractions of teaspoons.

7. The measuring spice dispenser of claim 1, wherein the wells have specific volumes of fractions of tablespoons.

8. The measuring spice dispenser of claim 1, wherein rotatable partitioned chamber further comprises volume designation indicating the specific volume of the well upon which it is printed.

9. The measuring spice dispenser of claim 1, wherein rotatable partitioned chamber is rotatable by a user.

10. The measuring spice dispenser of claim 1, wherein rotatable partitioned chamber carp rotate in a clockwise direction and can rotate in a counter-clockwise direction.

11. The measuring spice dispenser of claim 7, wherein the number of wells is four and the wells have specific volumes as follows: the first well measures ⅛ teaspoon, the second well measures ¼ teaspoon, the third well measures ⅓ teaspoon, and the fourth well measures ½ teaspoon.

12. The measuring spice dispenser of claim 7, wherein the number of wells is two and the wells have specific volumes as follows: ½ tablespoon and 1 tablespoon.

13. A method of dispensing a measured amount of spice comprising:
rotating rotatable partitioned chamber causing a triangle or other indicator on the primary storage container to line up with a corresponding volume designation on rotatable partitioned chamber:
inverting the dispenser to allow spice to travel from primary storage portion through aperture in the cover into a well of rotatable partitioned chamber;
rotating rotatable chamber to close the opening through which the spice travelled;
turning the dispenser to the upright position;
opening one side of rotatable bifunctional hinged lid; and
dispensing the spice.

14. The measuring spice dispenser of claim 1, wherein the primary storage portion comprises a first end and a second end, and wherein a first rotating partitioned chamber is mounted to the first end of the primary storage portion and a second rotating partitioned chamber is mounted to the second end of the primary storage portion, and further comprising an additional apertured cover replaces opening bottom before the second rotating partitioned chamber is attached to the primary storage portion.

15. The measuring spice dispenser of claim 14, wherein the first rotating partitioned chamber measures fractions of teaspoons and the second partitioned rotating chamber measures tablespoons.

16. The measuring spice dispenser of claim 1 fabricated in injection-molded, food-grade thermoplastic.

17. The measuring spice dispenser of claim 1 produced in a variety of sizes.
